(19) United States
(12) Patent Application Publication
(10) Pub. No.: US 2024/0137267 A1
(43) Pub. Date: Apr. 25, 2024

(54) METHODS AND SYSTEMS FOR ASSET UTILIZATION AND TRIGGER-BASED ACTION AUTOMATION

(71) Applicant: InnovoEdge, Inc., Wilmington, DE (US)

(72) Inventors: James Michael Brinksma, Rutherford, NJ (US); Alexander Kenneth Godwin, Baltimore, MD (US); Nathan Oliver Grey, Germantown, MD (US); Marcelo Alejandro McAndrew, Washington, DC (US); Stuart David McDonald, Fredericksburg, VA (US); Michael John Vitale, Denville, NJ (US)

(21) Appl. No.: 18/493,453

(22) Filed: Oct. 23, 2023

Related U.S. Application Data
(60) Provisional application No. 63/380,780, filed on Oct. 25, 2022.

(51) Int. Cl. H04L 41/0803; H04L 41/16

(52) U.S. Cl. CPC H04L 41/0803; H04L 41/16

(57) ABSTRACT

Systems and methods are provided for asset utilization and trigger-based automation. A network management system may receive a receive a network management configuration that identifies a configuration of a set of assets to be allocated to a service. The network management system may generate an asset utilization dataset including a set of utilization values associated with the set of assets generated over a time. The asset utilization data set may be used to train a machine-learning model configured to generated predictions corresponding to a future utilization associated with the set of assets. The network management system may then execute the machine-learning model predict utilization of a first asset. Upon determining that the predicted utilization is greater than a threshold, the network management system may execute an action associated with the set of assets.

This application claims the benefit of U.S. Provisional Patent Application No. 63/380,780, filed Oct. 25, 2022, the disclosure of which is herein incorporated by reference in its entirety for all purposes.

### TECHNICAL FIELD

This disclosure relates generally to monitoring asset utilization, and more particularly to monitoring asset utilization and trigger-based automation in public, private, and hybrid networks.

### BACKGROUND

Modern enterprise systems may include hardware and/or software assets that may be distributed throughout a variety of network types. For example, some sensitive asset may be deployed within private networks (e.g., such as networks operated by the enterprise). Less sensitive assets or assets for use by external users may be deployed within public networks (e.g., cloud network service providers that provide network services to a large set of users). Some assets may operate in both public and private networks (e.g., such as a web application operating in a public network that access databases of the private network).

Enterprise systems may manage assets deployed into public and/or private networks may receive network information from each network type. The information may vary according to the network type. In addition, the quality of information may also very (e.g., the age of the information by the time the information is received). The information disparity may make it difficult for the enterprise system to responds to changes in asset utilization. For example, the information disparity may delay the deployment of additional assets when a high asset utilization is detected disrupting services provided to users by the enterprise system. The reorganization of assets when the high asset utilization has passed may also be delayed needlessly tying up the resources of the public and/or private network.

### SUMMARY

Methods are described herein for asset utilization and trigger-based automation. The methods may comprise: receiving a network management configuration that includes a configuration of a set of assets to be allocated to a service; generating a utilization value indicative of a current utilization of the set of assets; generating an asset utilization dataset include a set of utilization values generated over a time interval; training, using the asset utilization dataset, a machine-learning model configured to generate a prediction corresponding to a future utilization associated with the set of assets; generating, using the machine-learning model, a predicted utilization of a first asset, wherein the predicted utilization is associated with a future time interval; determining that the predicted utilization is greater than a threshold; and executing, in response to determining that the predicted utilization of the first asset is greater than the threshold, an action associated with the set of assets.

Systems are described herein for asset utilization and trigger-based automation. The systems may include one or more processors and a non-transitory computer-readable medium storing instructions that, when executed by the one or more processors, cause the one or more processors to perform any of the methods as previously described.

Non-transitory computer-readable media are described herein for asset utilization and trigger-based automation. An example non-transitory computer-readable mediums may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts a block diagram of a network management system configured to monitor assets deployed within single and mixed network types according to aspects of the present disclosure.

FIG. 2A illustrates a first version of a graph of historical and predicted asset utilization with selectable historical and predicted data ranges according to aspects of the present disclosure.

FIG. 2B illustrates a second version of the graph of historical and predicted asset utilization with selectable historical and predicted data ranges according to aspects of the present disclosure.

FIG. 2C illustrates a third version of the graph of historical and predicted asset utilization with selectable historical and predicted data ranges according to aspects of the present disclosure.

FIG. 3 illustrates a graph of bandwidth usage corresponding to assets deployed within single or mixed networks according to aspects of the present disclosure.

FIG. 4 illustrates an open-high-low-close (OHLC) graph depicting the movement of historical bandwidth usage corresponding to assets deployed within single or mixed networks according to aspects of the present disclosure.

FIG. 5 illustrates a set of graphs indicating usage of various assets deployed within single or mixed networks according to aspects of the present disclosure.

FIG. 6 illustrates a flowchart of an example process for predicting asset utilization and with trigger-based automation according to aspects of the present disclosure

FIG. 7 illustrates an example computing device architecture of an example computing device that can implement the various techniques described herein according to aspects of the present disclosure.

### DETAILED DESCRIPTION

Managing network assets (e.g., central processing units, graphics processing units, memory, bandwidth, etc.) within networks is integral to ensuring continuity of services as network load changes over time. For example, increases in network bandwidth usage may cause a correspond decrease in network responsiveness, which may slow services provided by the network, prevent users from accessing services or resources, etc. Most networks are managed by waiting until utilization of an asset is greater than a threshold utilization before allocating additional quantities of the asset to the network. Yet, in some instances, by the time the additional quantities of the asset are allocated to the network, the network services have already been impacted.

The present disclosure includes systems and methods for asset utilization and trigger-based automation configured to proactively monitor asset utilization, predict future asset utilization, and automatically manage assets within private networks, public networks, and/or mixed (e.g., public and private) networks. A network may include a set of assets that may be utilized to provide services to users. Private networks may include assets that are provided and managed by a system or entity (e.g., such as an enterprise system, company, etc.). Public networks may include networks configured to provide services to one or more systems or entities. For example, a public network may be a cloud network in which a set of assets can of the cloud network can be allocated to each of multiple systems. In some instance, a network may be composed of one or more private networks (e.g., with the one or more private networks being operated by a same entity). In some instances, a network may be composed of one or more public networks (e.g., a network composed of network resources provided by one or more network providers such as a cloud network provider or the like that may provide network resources to multiple entities simultaneously). In some instances, a network may be composed of one or more private networks and one or more public networks.

A network management system may monitor real-time characteristics (e.g., asset utilization, hardware and/or software resources, etc.) of a network (or service) that comprising private networks, public networks, and/or mixed networks. One or more machine-learning models may be instantiated to identify dependencies within the utilization of assets (e.g., how memory utilization within a private network affects the central processing unit utilization of a public network, etc.) and generate predictions of future characteristics. The network management system may include automated triggers configured to automatically manage a network in response to the real-time characteristics or the predicted characteristics of the network. For example, the network management system may issue a notification that memory utilization within public network is predicted to exceed a threshold utilization within 30 days. Alternatively, or additionally, the network management system may automatically schedule the allocation of additional memory to the network based on the prediction that the threshed memory utilization is going to be exceeded within 30 days.

The network management system may provide efficient management of networks (or services) by preemptively allocating additional assets to a network (or service) before the asset utilization is high enough to impact the network (or service). The additional assets may be deallocated from the network (or service) once asset utilization falls below a threshold. The network management system may manage the allocation assets within the network (or service) to ensure that the network (or service) operates as designed, while preventing the over allocation (e.g., wasteful allocation) of assets.

The network management system may also predict how changes to the assets may impact the network (or service) to target actions within the network (or service). By targeting actions within the network, the network management system may maximize an impact of management actions on the network (or service), which may the efficient allocation of assets to the network (or service). For example, the network management system may determine whether increasing bandwidth within a private network will have an impact on data being processed within a public network. The network management system may then increase the bandwidth within the private network to improve data processing with the public network. The network management system can efficiently and proactively manage assets allocated to public networks, private networks, mixed networks, services deployed with any of the aforementioned networks, etc.

In one illustrative example, a network management system may receive a network management configuration that includes a configuration of a set of assets to be allocated to a service. The network management system may be configured to manage assets of one or more networks, services (e.g., provided by an entity such as a company, enterprise system, or the like), and/or entities. For example, the network management system may be configured to manage a particular network operated by an enterprise system. The particular network may include one or more private networks (e.g., defined, operated, and/or managed by the enterprise system) and/or one or more public networks that operate together to provide a service to users. The network management system may receive the network management configuration from a device associated with the service. Alternatively, or additionally, the network management system may receive the network management configuration from internal or remote memory. In those instances, the network management configuration may be generated by the network management system (e.g., by a device or user thereof, or the like).

The network management configuration may include an identification of the one or more assets to be allocated to the service and that are to be managed by the network management system (e.g., such as a serial number of the asset, globally unique identifier assigned to the asset, a description of the asset, an age of the asset, etc.), an identification of any dependencies between an asset and other assets of the set of assets (if any such dependencies exists or is known), an identification of one or more thresholds for each asset class (e.g., volatile memory, non-volatile memory, central processing units, graphics processing units, bandwidth, device type, etc.), an identification of one or more thresholds of each asset, combinations thereof, or the like. The network management configuration may control how the set of assets are managed as the service operates. For example, the network management configuration may indicate when additional assets are to be allocated to the service during periods of high processing load or when assets may be deallocated from the service during periods of low processing load.

The network management system may generate a utilization value indicative of a current utilization of the set of assets. The network management system may generate utilization value for each asset, for each asset class, for each network in which the service is deployed, for each network of the enterprise system that is providing the service, combinations thereof (e.g., for each asset class in each network, etc.), or the like. The utilization value may be an integer, real number, percentage, or the like indicative of a quantity of the asset that is being utilized by the service. For example, for a graphics processing unit asset class, the utilization value may indicate a quantity of the processing power of the graphics processing units allocated to the service that is in use by the service.

The network management system may receive utilization information that includes characteristics associated with the set of assets, the service, the devices in which the services is operating, the networks in which the service is operating, combinations thereof, or the like from which the utilization value may be generated. The network management system may receive some utilization information by requesting the utilization information from a network, system, device, etc. providing an asset of the set of assets. The network management system may receive some utilization information directly using an application programming interface (API) of a network, system, device, etc. to access the utilization information. In some instances, the network management system may receive the utilization information in real time (e.g., as a series of datasets, as a continuous stream, etc.). For example, the real-time information may correspond to the current state of the set of assets.

The network management system may generate an asset utilization dataset that corresponds to a sequence of utilization values generated over a predetermined time interval. The asset utilization is usable to train various algorithms, statistical models, machine-learning models, etc. The predetermined time interval may be selected based on previously training iterations (e.g., of the algorithms, statistical models, machine-learning models, etc.), an intended accuracy metric (e.g., accuracy, precision, area under the curve, logarithmic loss, F1 score, mean absolute error, mean square error, etc.) once training is to be completed, user input, combinations thereof, or the like.

For example, the accuracy of the machine-learning model may be based on the quantity and quality of the information used to train the machine-learning model. The quantity of the information may be selected by adjusting the predetermined time interval. Increasing the predetermined time interval may increase the accuracy of predictions generated by the machine-learning model once trained (e.g., at the expense of the time needed to train the machine-learning model). Reducing the predetermined time interval may reduce the quantity of time needed to train the machine-learning model and enable use of the machine-learning model in instances when little data is available (e.g., such as for new services). For example, the network management system may generate an asset utilization dataset comprising the utilization values of the set of asserts over the last 30 days for use in training a machine-learning model to generate predictions of the utilization of an asset at a future time (or over a future time interval).

The network management system may use then utilization dataset to train a machine-learning model configured to generate a prediction corresponding to one or more future characteristics (e.g., such utilization, failure, etc.) associated with the set of assets. Examples of machine-learning models may include, but are not limited to neural networks, recurrent neural networks, concurrent neural networks, deep learning networks, support vector machines (SVM), clustering, linear or logarithm regression classifiers, Naïve Bayes, Nearest Neighbor, adversarial networks, etc. The machine-learning model may be configured to generate single or multivariate predictions associated with the set of assets.

The machine-learning model may be trained using supervised learning, unsupervised learning, semi-supervised learning, reinforcement learning, combinations thereof, or the like. The network management system may train the machine-learning model over a predetermined quantity of iterations or until a predetermined accuracy threshold is reached (e.g., accuracy, precision, area under the curve, logarithmic loss, F1 score, mean absolute error, mean square error, etc.).

In some instances, the network management system may train two or more machine-learning models using the same utilization dataset. The two or more machine-learning models may be of a same type or of different types. The two or more machine-learning models may be used to generate comparative predictions of one or more future characteristics. The network management system may execute each of the two or more machine-learning models to generate a corresponding two or more predictions associated with the set of assets and evaluate the two or more predictions for accuracy, precision, etc. The network management system may then select the prediction having a highest evaluation (e.g., highest accuracy, precision, etc.) for use in managing the set of assets and/or for presentation to the device associated with the service, a user associated with the service (e.g., such as an administrator of the service, etc.), or the like. Each time a prediction associated with the set of assets is to be generated, the network management system may execute the two or more machine-learning models and selected the corresponding output having the highest evaluation.

Alternatively, or additionally, the network management system may select the machine-learning model that generated the prediction having the highest evaluation. The network management system may use the predictions to manage the set of assets and/or present the predictions to the device associated with the service, a user associated with the service, users of the network management system, or the like. The selected machine-learning model may be configured to generate predictions associated with the service. The selected machine-learning model may continue to generate predictions associated with the service until one or more accuracy metrics of the machine-learning model fall below predetermined thresholds or until another machine-learning model is selected. For example, the network management system may continuously evaluate the two or more machine-learning models to identify the machine-learning model of the two or more machine-learning models configured to generate predictions with a highest evaluation. The network management system may select the machine-learning model configured to generate the predictions with a highest evaluation as the primary machine-learning model. If another machine-learning model of the two or more machine-learning models begins generating predictions with a higher evaluation than the primary machine-learning model, then the other machine-learning model will become the new primary machine-learning model. The network management system may continuously evaluate the two or more machine-learning models and always use the machine-learning model that is best suited to generate predictions associated with the set of assets

In some instances, two or more machine-learning models may be configured to operate together to increase the accuracy of the predictions generated by the network management system. For example, the two or more machine-learning models may be configured into an adversarial network wherein the output from a first machine-learning model may be passed as input into a second machine-learning model (and the output of the second machine-learning model may be passed as input into the first machine-learning model) to improve how predictions are generated by the first and/or the second machine-learning models. In the adversarial network, the first machine-learning model may be configured to generate predictions associated with the set of assets and the second machine-learning model may be configured to evaluate characteristics associated with the predictions (e.g., accuracy, precision, deviation, etc.). The output from the second machine-learning model may be usable to train the first machine-learning model (e.g., via supervised or reinforcement learning). Alternatively, or additionally, the two or more machine-learning models may be configured into an ensemble model in which the output of a first machine-learning model is an intermediary output usable as input into one or more next machine-learning models similar in structure to a multiple-layered neural network. The last machine-learning model of the ensemble model may generate a final output.

The network management system may execute the machine-learning model (or multiple machine-learning models if implemented) to generate a predicted utilization of an asset at a future time. The future time may be a feature passed as input (along with other characteristics of the set of assets, the services, etc.) that may be selected by the network management system (e.g., based on a quantity of data used to train the machine-learning model, a quantity of available historical data used as input to the machine-learning model, etc.), user input, or the like. The future time may be a particular time instant or a time interval. For example, when a time instant is selected, the predicted utilization may correspond to a predicted utilization of the asset at that time instant. When a time interval is selected, the predicted utilization may correspond to a sequence of predicted utilizations of the asset over the time interval.

In some instances, the machine-learning model may be configured to generate a predicted utilization of each asset class or of each asset of the set of assets. The network management system may use the predicted utilization to generate a predicted state of the set of assets, the service, the networks within which the service is operating, etc. at the future time. The network management system may use the predicted utilization to execute an action associated with the set of assets and/or the service such as, for example, requesting additional assets be allocated to the service, allocating additional assets to the service, requesting deallocation of assets from the service, deallocating assets from the service, requesting replacement of an asset, replacing an asset, requesting an asset be moved from one network to another network, moving an asset from one network to another network, identify dependencies between asset class or assets, generate a notification to the device and/or user associated with the service, generate an interface configured to present the real-time characteristics associated with the set of assets and/or the service, generate an interface configured to present the generated predictions, combinations thereof, or the like.

For example, the network management system may determine that a predicted utilization of a first asset of the set of assets is greater than threshold. In other words, the network management system predicts that the utilization of the first asset will be greater than the threshold at the future time. The network management system may generate a state of the set of assets, the service, and/or the network in which the service operates at the future time (e.g., generating the predicted utilization of each asset class and/or asset at the future time). The network management system may then determine whether an action should be executed to improve the efficiency of the the set of assets, the service, and/or the network in which the service operates.

In some instances, the network management system may define multiple thresholds. The thresholds may be defined according to an escalating asset utilization. The network management system may determine the action to execute based on the particular threshold or thresholds that have been exceeded. For example, the thresholds for memory utilization may be 60%, 75%, and 90%. The network management system may determine that if the predicted memory utilization is greater than 60% but less than 75%, than a notification is to be transmitted to the device and/or user associated with the service. If the predicted memory utilization is greater than 75% but less than 90%, than a request to add additional memory assets to the service may be transmitted to the device and/or user associated with the service. If the predicted memory utilization is greater than 90%, than the network management system may automatically allocate additional memory assets to the service to prevent the service from being impacted.

The network management system may then execute the determined action in response to determining that the predicted utilization of the first asset is greater than the threshold. The action may correspond to any of the previously described actions. For example, if the predicted memory utilization indicates that the memory utilization is predicted to be greater than a threshold (e.g., 80% utilization) in the next seven days, the network management system may request that additional memory be allocated to the service.

In some instances, the network management system may determine where the determined action is to be executed to have the largest impact on the service. For example, a service may be provided using a combination of a private network and a public network, in which the private network transmits data to the public network to provide the functionality of the service. When the network management system predicts a high non-volatile memory utilization within the next 30 days, the network management system may recommend additional memory be allocated to the service. Allocating additional non-volatile memory in the public network may have limited impact on the non-volatile memory utilization of the service because the data is stored in the private network. The network management system may determine the allocating additional non-volatile memory assets within the private network will have a larger impact on the service by reducing the overall non-volatile memory utilization of the service.

The network management system may evaluate the asset classes, assets of the set of assets, networks in which the service operates, combinations thereof, or the like to determine how allocating or deallocating assets within different networks or at different locations may affect other asset classes, assets of the set of assets, networks in which the service operates, etc. In some instances, the network management system may train and execute an action-prediction machine-learning model (e.g., such as the aforementioned machine-learning model, a different machine-learning model, etc.) configured to predict an effect of action on the service. Returning to the example above, the action-prediction machine-learning model may predict a first result of allocating additional non-volatile memory within the public network and a second result of allocating additional non-volatile memory within the private network. The network management system may then determine which result (e.g., the first or the second) corresponded to a better outcome for the service. The first and second result may be a predicted utilization of the set of assets (as previously described) that is subject to the constraints of the action. Alternatively, or additionally, the first and second result may be a score indicative of a degree in which the action improved the service (e.g., based on any metric associated with the state of the service such as, but not limited to, efficiency, failure rate, false positives, false negatives, resource consumption, user complaints, etc.). The network management system may then target execution of the action based on the action-prediction machine-learning model.

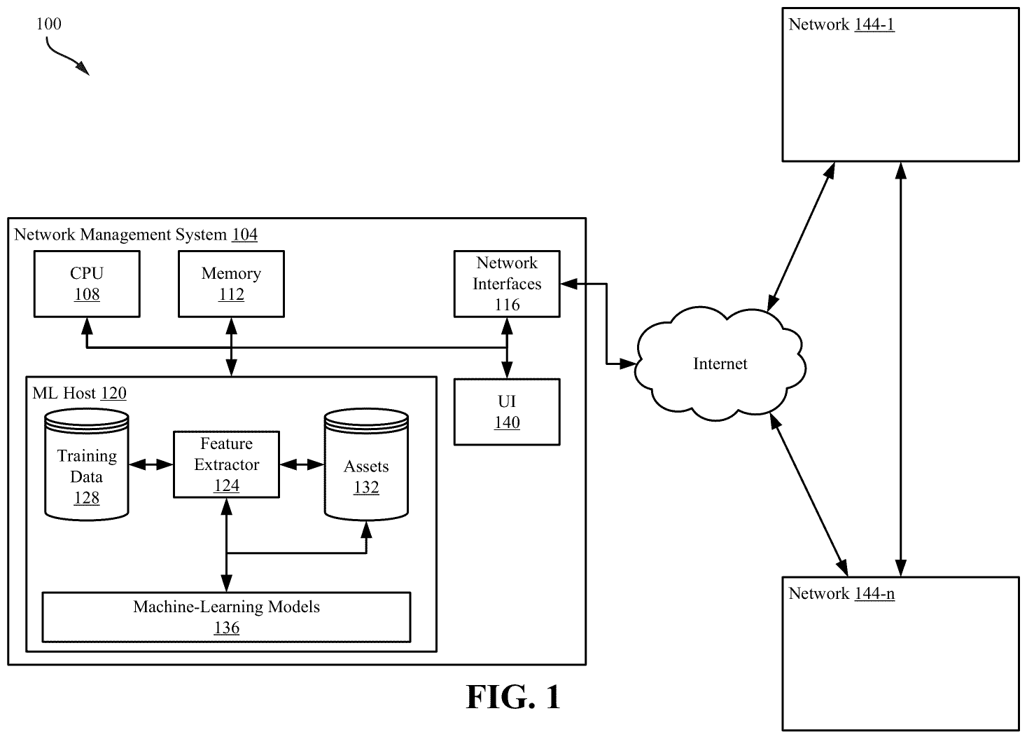

FIG. 1 depicts a block diagram of a network management system configured to monitor assets deployed within single and mixed network types according to aspects of the present disclosure. Network management system 104 may include one or more computing devices, servers, networks (e.g., such as local-area networks, wide-area networks, cloud networks, etc.) configured to manage assets associated with a network or service. Examples of assets include, but are not limited to volatile memory, non-volatile memory, central processing units, graphics processing units, bandwidth, devices (e.g., computing devices, servers, routers, network switches, power supplies, storage devices, etc.), or the like. As shown, network management system 400 may include a central processing unit (CPU 108) in communication with, memory 112 (e.g., volatile and/or non-volatile memories), network interface 116, ML Host 120, and user interfaces (UI 140) connected via a bus (or other mechanism). In instances in which network management system 104 includes multiple devices, the devices may include the same components as shown or different components.

Network management system 104 may manage assets of a device, network service, etc. The assets may include physical and virtual devices and/or software such as, but not limited to, non-volatile memory devices, volatile memory devices, central processing units, graphics processing units, bandwidth, devices (e.g., such a computing devices; networks devices such as gateways, routers, switches, etc.; servers, databases, application-specific integrated circuits, field programmable gate arrays; mask programmable gate arrays; power supplies; etc.), software,

Network interfaces 116 may include a set of interfaces configured to enable communications between network management system 104 and one or more remote networks such as network 144-1 through network 144-n. Network interfaces 116 may include standard network interfaces for communicating over Internet-Protocol-based networks (e.g., such as TCP/IP networks) such as the Internet. In some instances, network interfaces 116 may also include interfaces configured to communicate directly or indirectly with a network or service operating non-standard communication protocols (e.g., proprietary communication protocols, legacy networks operating legacy communication protocols, etc.). Network management system 104 may receive interfaces from a device, network, service, etc. operating a non-standard communication protocol; retrieve the interfaces from a database or remote device; define the interfaces based on an analysis of packets or other communications from the device, network, service, etc. operating a non-standard communication protocol; combinations thereof, or the like.

ML Host 120 includes computing devices and/or software configured to monitor assets associated with devices, networks, and/or services. ML Host 120 may also include triggers configured to automatically respond to conditions of the assets by, for example, modifying the assets (e.g., facilitating allocation of additional assets, facilitating the deallocation of assets, replacing assets, routing communications or data through a device or network, etc.), transmitting communications (e.g., such as notifications, alerts, etc.), generating interfaces configured to display monitored characteristics (e.g., of devices, networks, and/or services), combinations thereof, or the like.

ML Host 120 may receive an asset dataset from each device, network, service, etc. which is to be managed by the network management system 104. The asset dataset may include information associated with each asset such as, but not limited to, an identification of the one or more assets that are or will be allocated to the device, network, or service and that are to be managed by the network management system (e.g., such as a serial number of the asset, globally unique identifier assigned to the asset, a description of the asset, etc.), characteristics of the one or more assets (e.g., an age of the asset; a time interval over which the asset has been in use by the device, network, or service; a storage capacity of the asset; a processing capacity of the asset; a quantity of computing cores of the asset; etc.), an identification of any dependencies between an asset and other assets of the one or more assets (if any such dependencies exists or is known), combinations thereof, or the like. The asset dataset may be stored in a database (e.g., assets 132), which may be stored within a single device or distributed among multiple devices of network management system 104.

ML Host 120 may also receive one or more data streams including real-time and/or historical characteristics of the one or more assets management by network management system 104. In some instances, ML Host 120 may request access to the including real-time and/or historical characteristics. In other instance, ML Host 120 may include access to an application programming interface exposed by the device, network, service, etc. which is to be managed by the network management system 104. The application programming interface may enable ML Host 120 to obtain the real-time and/or historical characteristics from the corresponding device, network, service, etc. The characteristics may include, but are not limited to utilization of the asset (e.g., relative to a total capacity of the asset and/or relative to a total capacity of the asset class); a time interval over which the asset has been operating for the device (e.g., also referred to as up-time), network, service, etc.; a failure or error rate of the asset (e.g., processor interrupts, processor stalls, memory read/write errors, memory locks, etc.), combinations thereof, or the like).

Feature extractor 124 may extract features from the data stream that may be usable to train machine-learning models, algorithms, statistical models, etc.; to generate predictions associated with assets (e.g., predict future values of characteristics associated with the assets, etc.); generate interfaces configured to present the features, etc. Feature extractor 124 may define features from the data stream and organize the features into sets of features. Each set of features may correspond to features extracted over a particular time interval (e.g., using an overlapping or non-overlapping window, etc.). For example, feature extractor 124 may define a window of 30 seconds and extract a set of features from the data stream that are within the moving window (e.g., all features from T=0 seconds to T=30 seconds). The length of the window may be of a predetermined length (e.g., selected by feature extractor 124, network management system 104, user input, or the like) or a value selected based on historical executions of machine-learning models 136.

Feature extractor 124 may then iterate the window. For overlapping windows, the window may be moved by a value less than 30 (e.g., selected by feature extractor 124, user input, or the like). such that the window captures a portion of the previous window. For example, the new window may capture features from T=1 seconds to T=31 seconds of the data stream (e.g., where T=1 second to T=30 seconds include features captured within the previous window). For non-overlapping windows, the window may be moved by a value (e.g., selected by feature extractor 124, user input, or the like) greater than or equal to 30. For example, the new window may capture features from T=31 seconds to T=60 seconds of the data stream (e.g., such that each window captures a unique set of features from the data stream).

Feature extractor 124 may determine an optimal window length and values for overlapping windows and non-overlapping windows by generating multiple sets of features with different window lengths and values for overlapping windows and non-overlapping window. Feature extractor 124 may execute machine-learning models 136 using the multiple sets of features to generate predictions. The predictions may be evaluated for accuracy, precision, etc. to determine which set of features caused each machine-learning model to generate the highest evaluated prediction (e.g., according to one or more accuracy metric, etc.). The window length and values for overlapping windows or non-overlapping window used to generate that set of features may be used to generate future feature vectors for that machine-learning model. Each machine-learning model may identify a set of features generated from different window lengths and values for overlapping windows or non-overlapping windows. Feature extractor 124 may determine for each machine-learning model, the optimal window length and values for overlapping windows and non-overlapping windows.

Feature extractor 124 may process each set of features to generate a feature vector usable as input to a model, machine-learning model, algorithm, process, etc. Feature vectors may include a sequence of features organized according to a particular domain (e.g., such as time, etc.). In some instances, feature extractor 124 may perform a dimensionality reduction process (e.g., such a principal component analysis, etc.) on the set of features before generating the feature vector. In some instances, feature extractor 124 may also perform other processes (e.g., feature engineering to expand the quantity of features, embeddings, etc.).

Feature extractor 124 may store a set of feature vectors in training data 128. Training data 128 may include datasets usable to train a machine-learning model. The datasets may include historical data, procedurally generated data, manually generated data, combinations thereof, or the like. In some instances, feature extractor 124 may determine a minimum quantity of datasets needed to train machine-learning models 136. Feature extractor 124 may then a corresponding quantity of historical data. If an insufficient quantity of historical data is available, the remaining portion of the minimum quantity of datasets may be filled with procedurally generated data and/or or manually generated data.

Feature extractor 124 may pass feature vectors to machine-learning models 136 to training machine-learning models 136 and to execute machine-learning models 136 to generate predictions associated with a set of assets, a device, a network, a service, etc. Examples of machine-learning models that may be included in machine-learning models 136 may include, but are not limited to neural networks, recurrent neural networks, concurrent neural networks, deep learning networks, support vector machines (SVM), clustering, linear or logarithm regression classifiers, Naïve Bayes, Nearest Neighbor, adversarial networks, or the like. Each machine-learning model of machine-learning models 136 may be trained using supervised learning, unsupervised learning, semi-supervised learning, reinforcement learning, combinations thereof, or the like. Each machine-learning model may be trained over a predetermined quantity of iterations or until a predetermined accuracy threshold is reached (e.g., accuracy, precision, area under the curve, logarithmic loss, F1 score, mean absolute error, mean square error, etc.).

Feature extractor 124 may continuously monitor the accuracy metrics (e.g., accuracy, precision, area under the curve, logarithmic loss, F1 score, mean absolute error, mean square error, etc.) of a machine-learning model to determine if retraining or a new machine-learning model is needed. For example, if one or more accuracy metrics fall below threshold values, then the machine-learning model may be retrained, a reinforcement training iteration may be performed, or the machine-learning model may be deleted and a new machine-learning model (of a same or different type) may be instantiated and trained to replace the deleted machine-learning model.

UI 140 may include components configured to generate representations of the data stream and/or the predictions generated by the machine-learning models 136. The representations may include graphical user interfaces that may include a representation of the real-time data of the data stream, historical data of the data stream, a predicted future of the data stream, etc. In some instances, the representations may include graphs (e.g., bar charts, line charts, candlestick charts, pen-high-low-close (OHLC) charts, pie charts), tables, graphics or images, etc. The representations may be static (e.g., unchanging) or dynamic (e.g., changing in response to selection of one or more inputs). For example, the representations may change upon receiving a selection of a time interval over which the data of the data stream is to be presented, a future time interval over which predictions are to be presented, a quantity of data to be presented, a type of data to be presented (e.g., particular asset or asset class, characteristics for the particular asset or asset class such as utilization values or error rates, etc. UI 140 may also be configured to transmit notifications, alerts, etc. to devices and/or users associated with the device, network, service, or the like. being managed by network management system 104. The notifications, alerts, etc. may be transmitted directly by UI 140 or through network interfaces 140.

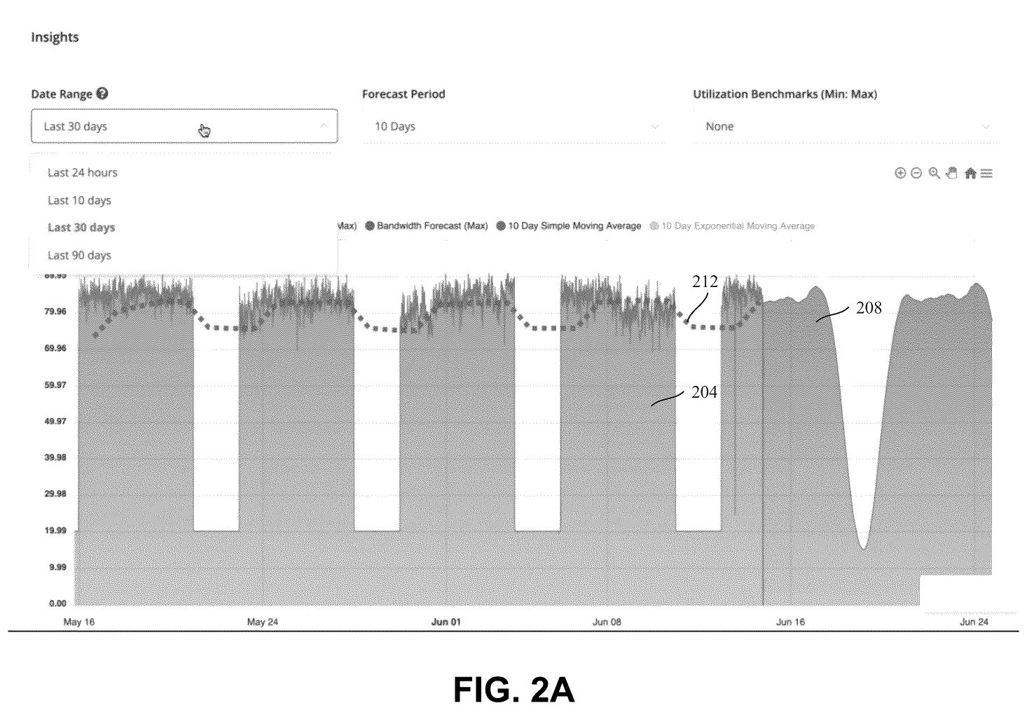

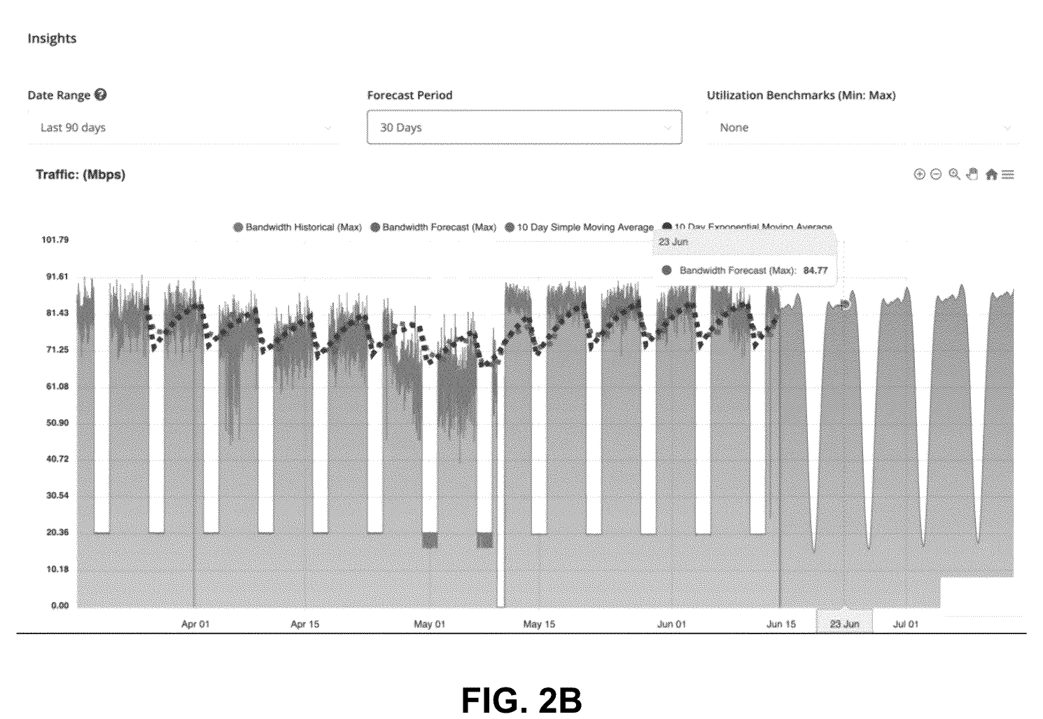

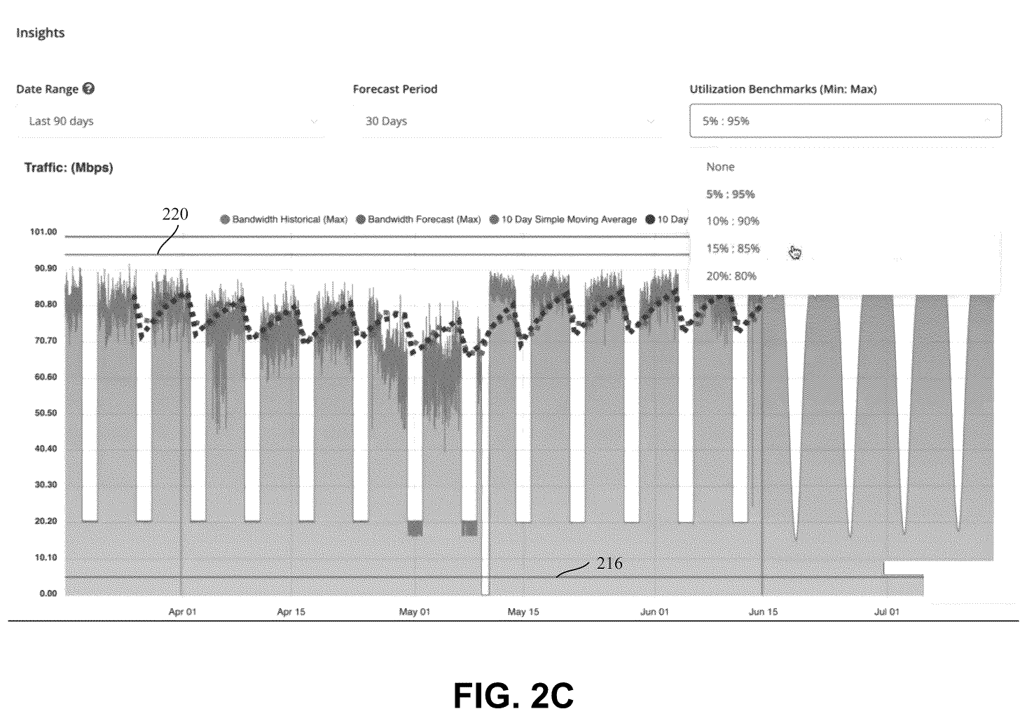

FIG. 2A illustrates a first version of a graph of historical and predicted asset utilization with selectable historical and predicted data ranges according to aspects of the present disclosure. The graph includes a representation of bandwidth utilization (e.g., represented by the y-axis in Mbps) within a network over time (e.g., represented by the x-axis). A first portion 204 of the representation includes historical utilization of bandwidth within the network up to a current time. A second portion 208 of the representation includes a predicted utilization of the bandwidth over a future time interval (e.g., from the current time extending into the future to a future time). One or more statistical values of the utilization data may be plotted on top of the graphed utilization values (or alternatively via a separate graph). For example, the dotted line 212 represents a 10-day simple moving average of the utilization values.

The interface presenting the graph may include one or more configuration parameters that can be selected to automatically adjust the graph. For example, a first drop-down menu may present various time intervals over which the historical data may be plotted within the graph. As shown, 30 days is selected causing the graph to display the previous 30 days of historical bandwidth utilization. A second drop-down menu may present various future time intervals over which the bandwidth utilization is to be predicted. As shown, 10 days is selected causing the graph to display predicted bandwidth utilization over the next 10 days. A third drop-down menu may present benchmarks that be displayed over the first portion 204 and/or the second portion 208. The values of any of the configuration parameters can be selected or changed to automatically update the graph based on the selected configuration parameters.

FIG. 2B illustrates a second version of the graph of historical and predicted asset utilization with selectable historical and predicted data ranges according to aspects of the present disclosure. The second version of the graph includes a representation based on a selected configuration parameter (within the first drop-down menu) corresponding to 90 days of historical utilization data and a selected configuration parameter (within the second drop-down menu) corresponding 30 days (e.g., the forecast time interval). Upon selection, the first version of the graph (of FIG. 2A) may automatically change to the second version of the graph (shown in FIG. 2B) in which the bandwidth utilization is shown over the previous 90 days (from the current time) and the predicted bandwidth utilization is forecasted for the next 30 days.

FIG. 2C illustrates a third version of the graph of historical and predicted asset utilization with selectable historical and predicted data ranges according to aspects of the present disclosure. The third version of the graph includes the second version of the graph with benchmarks selected (e.g., configuration parameter selected within the third drop-down menu. The benchmarks may include thresholds that can be presented on top of the graph. For example, a 5% min 90% max benchmark is selected enabling a presentation of a first threshold 216 corresponding to 5% utilization and a second threshold 220 corresponding to a 90% utilization of the bandwidth. Benchmarks may be selected from predetermined benchmarks in a drop-down menu (as shown) or selected from user input (e.g., as integers, real numbers, percentages, etc.). In some instances, the benchmarks may modify the graph to highlight the portion of the graph that corresponds to the benchmarks. For example, the portion of the graph under threshold 216 may be represented as a first color, the portion of the graph between the first threshold 216 and the second threshold 220 may be represented as a second color, and the portion of the graph that is over the second threshold 220 may be represented as a third color. The colors may be representative of a degree in which the utilization may impact other assets, the device, network, service, or the like. For example, the first color may be green, the second color may be yellow, and the third color may be red to indicate that the bandwidth utilization is too high and may begin impacting the other assets, the device, network, service, or the like.

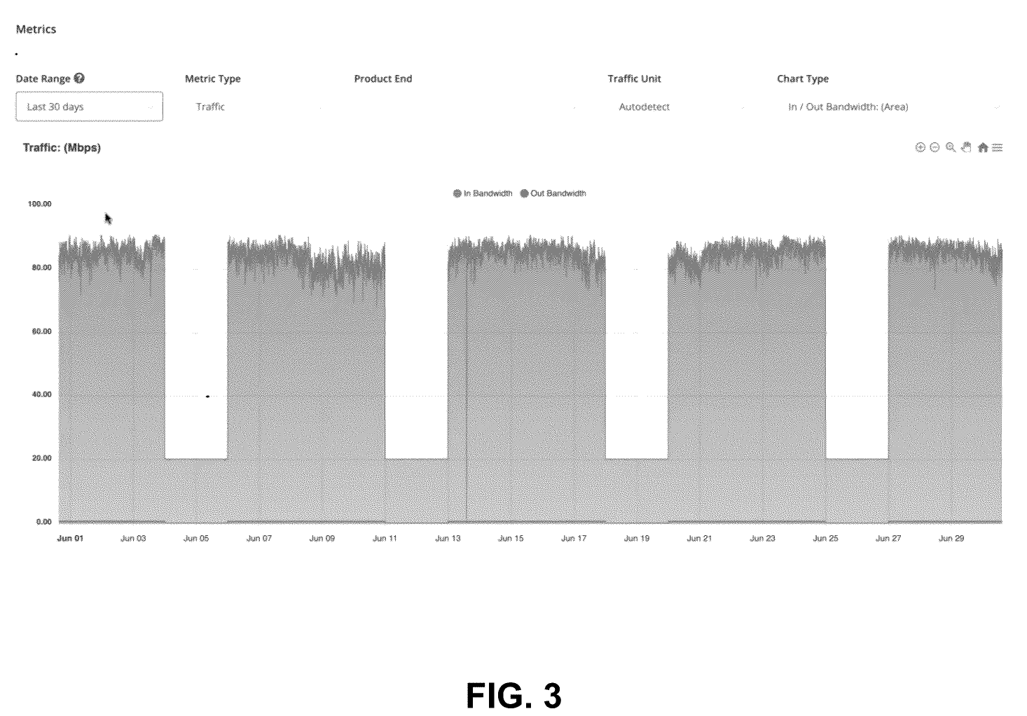

FIG. 3 illustrates a graph of bandwidth usage corresponding to assets deployed within single or mixed networks according to aspects of the present disclosure. Characteristics associated with particular assets can be presented to visually represent the characteristics to users. The visual representation may be graphs (as shown), graphics, images, video, sounds, or the like. Various parameters can be selected to define the representation. For example, as shown, the parameters include a first time interval corresponding to a time interval over which the characteristics collected are to be presented (e.g., the past 30 days as shown, etc.), a metric type (e.g., a characteristic such as bandwidth as shown, etc.), product (e.g., a device, network, services within which asset utilization is to be displayed), unit (e.g., a unit of the metric to be displayed such as Mbps as shown, etc.), a chart type (e.g., a graph type, graphic type, image type, etc.). The graph of FIG. 3 depicts the bandwidth utilization (e.g., bandwidth of traffic exiting the network) of a network over the previous 30 days.

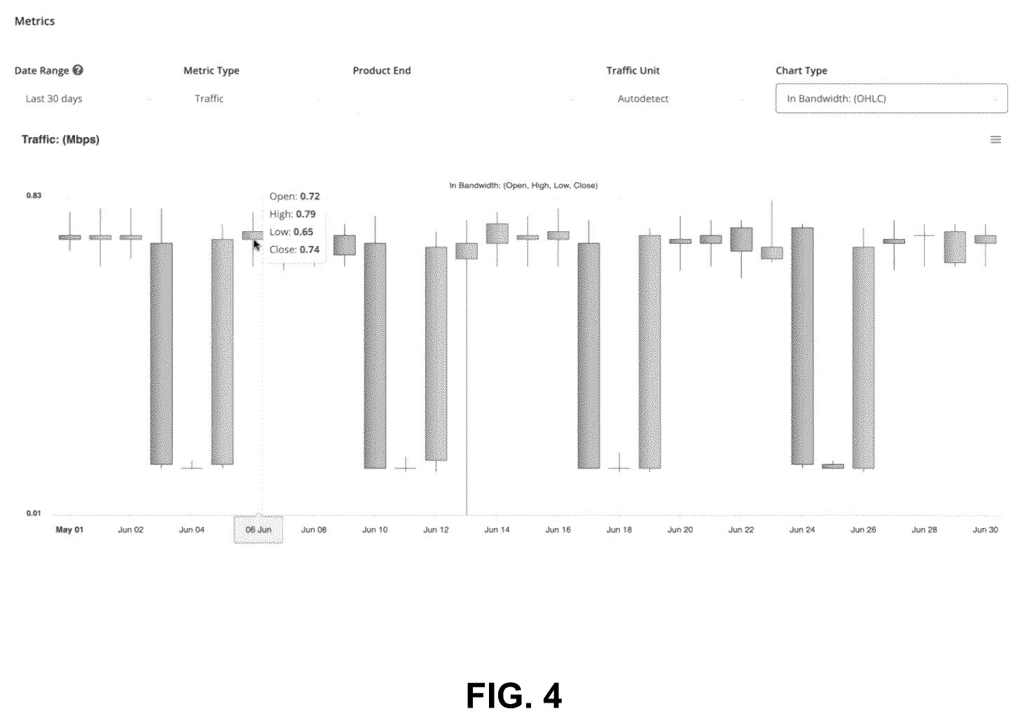

FIG. 4 illustrates an open-high-low-close (OHLC) graph depicting the movement of historical bandwidth usage corresponding to assets deployed within single or mixed networks according to aspects of the present disclosure. The graph of FIG. 4 includes the different chart (e.g., an OHLC graph) type from the graph depicted in FIG. 3. The OHLC graph provides a representation of changes in bandwidth utilization over time. For example, each discrete time interval (e.g., a day according to the x-axis) corresponds to a range of bandwidth utilization values including: the bandwidth utilization at the beginning of the time interval, the bandwidth utilization at the end of the time interval, the lowest bandwidth utilization within the time interval, and the highest bandwidth utilization within the time interval. The four values of each discrete time interval within the longer time interval (over which the graph is represented) may be used to generate a representation of the bandwidth utilization over that time interval.

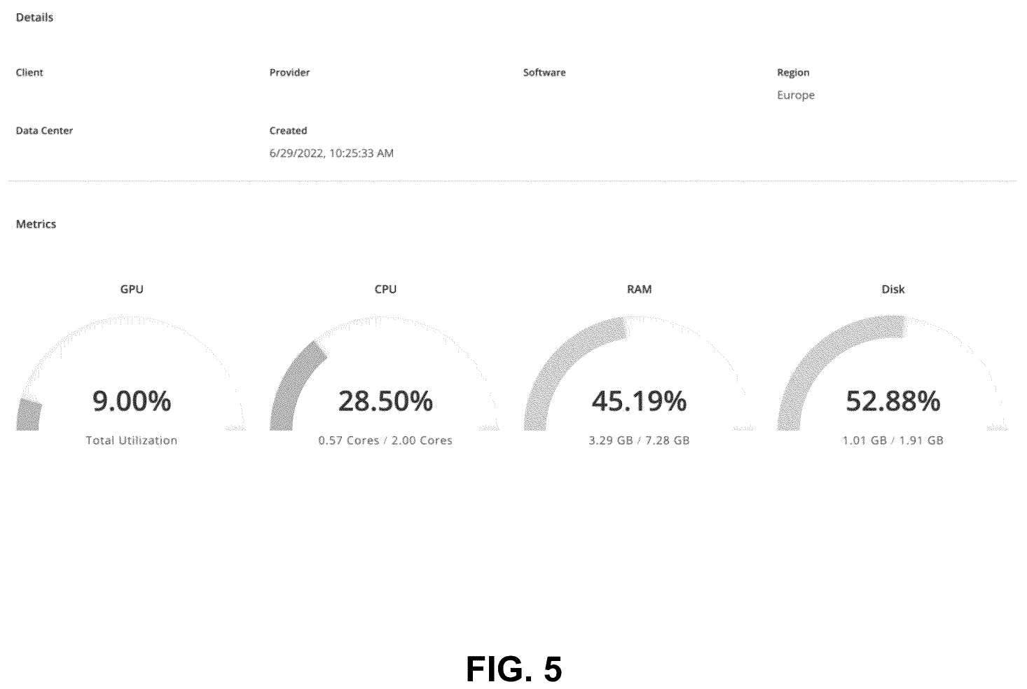

FIG. 5 illustrates a set of graphs indicating usage of various assets deployed within single or mixed networks according to aspects of the present disclosure. The set of graphs provide a snapshot of the state of the assets being managed by a network management system. The interface may include the set of graphs as well as an identification of the parameters associated with the set of graphs including an identification of the device, network, or service being managed (e.g., referred to as the client); an identification of a provider of the device, network, or service (e.g., referred to as the provider) such as a public network entity, etc.; a region within which the characteristics of the assets are being represented by the set of graphs; an identification of a data center associated with the assets, the date in which the set of graphs were generated; software associated with the set of assets (e.g., such as the software used to generate the graphs, machine-learning models, etc.); etc.

The set of graphs represent various characteristics of the assets being managed. As shown, the set of graphs represent the total graphics processing unit utilization, central processing unit utilization (e.g., based on processing cores), volatile memory (e.g., RAM) utilization, and the non-volatile memory (e.g., disk) utilization. One or more parameters may be selected to configure the set of graphs including adding additional graphs, removing graphs, selecting a chart type, selecting a characteristic to be presented by a particular graph, selecting a time interval over which values of the characteristic are to be presented by a particular graph (e.g., a current time for real time presentations, a historical time or time interval, forecasted time or time interval, etc.), selecting the units in which the characteristic is to be displayed, selecting a numerical display type (e.g., integers, real numbers, percentages, average, median, rolling average), selecting colors configured to highlight the status of a characteristic, selecting benchmarks, or the like.

The graphs described in FIGS. 2-5 may present real time data, historical data, and/or future data (e.g., as predicted by machine-learning models as previously described). The graphs may be presented via a graphical user interface (e.g., as shown), that may be generated with an application executing on the network management system. Alternatively, or additionally, the user interfaces may be generated via a web-based application accessible to devices and/or users associated with the assets being managed by the network management system (e.g., such as administrators of the devices, networks, services, etc. in which the assets are deployed or configured to operate, etc.). The graphs and/or user interfaces may be fully customizable to present the historical, current, or predicted values of any characteristic monitored by the network management system in any particular form or format (e.g., numerically, graphically using static or dynamic graphics as shown or using video, audibly, combinations thereof, or the like).

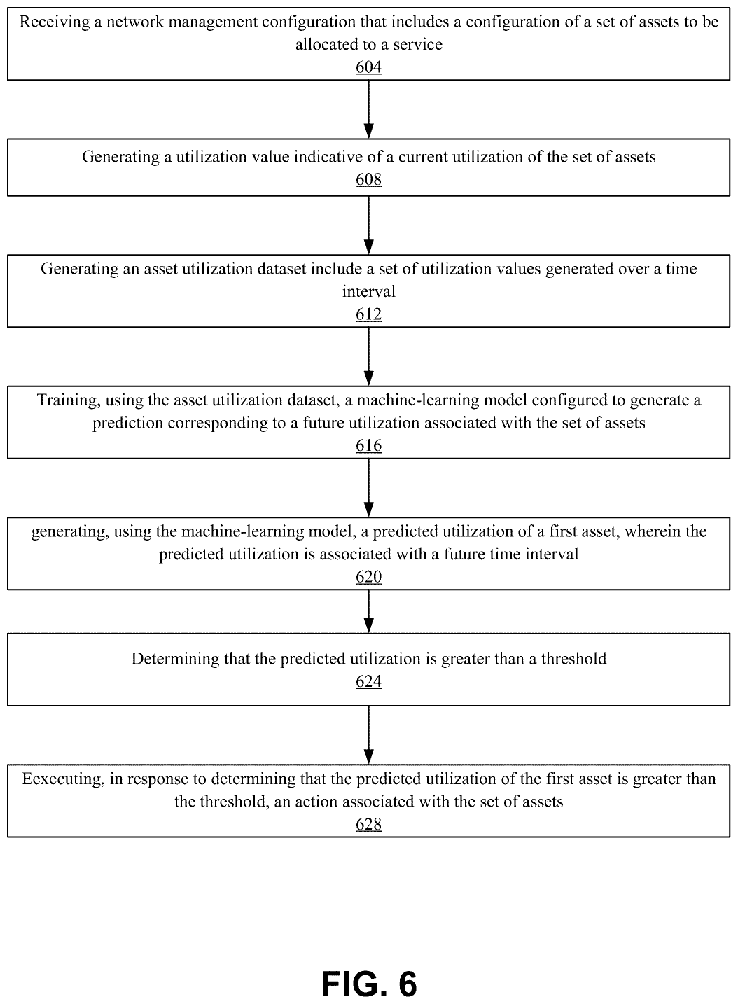

FIG. 6 illustrates a flowchart of an example process for predicting asset utilization and with trigger-based automation according to aspects of the present disclosure. At block 604, a network management system may receive a network management configuration that defines a configuration of a set of asserts to be allocated to a service (or already allocated to a service). The network management system (e.g., such network management system 104 of FIG. 1) may include one or more computing devices, servers, databases, networks, combinations thereof, or the like. Alternatively, or additionally, the network management system may be one or more software components that executed by a computing device, by multiple computing devices in a distributed environment, in a cloud environment, etc. to provide the functionality of the network management system.

The network management system may be configured to manage assets of one or more device, networks, services (e.g., provided by an entity such as a company, enterprise system, or the like), and/or entities. The service may be provided by one or more private networks (e.g., defined, operated, and/or managed by an enterprise system or an entity) and/or one or more public networks (e.g., networks that provide services to one or more entities, etc.) that operate together to provide the service. Assets may include any computing component that contributes to the facilitation of the service. Examples of assets include, but are not limited to, volatile memories (e.g., random access memory (RAM), cache memory (L1, L2, L3, L4, virtual cache, etc.), non-volatile memories (e.g., hard disk drives, flash memory, etc.), central processing units (CPUs), graphics processing units (GPUs), bandwidth (e.g., as provided by one or more hardware devices such as, but not limited to, modems, routers, network switches, etc.), devices (e.g., any physical processing device, such as, but not limited to, application-specific integrated circuits, field or mask programmable gate arrays, computing devices, mobile devices, servers, storage devices, etc.), or the like.

The network management system may receive the network management configuration from a device or user associated with the service (e.g., such as an administrator). Alternatively, or additionally, the network management configuration may be generated by the network management system (e.g., by a device or user thereof, or the like). In those instances, the network management system may receive the network management configuration from internal or remote memory.

The network management configuration may include an information associated with the set assets that are to be allocated to the service (or already allocated to the service) and that are to be managed by the network management system. The information may include, but is not limited to an identification of the set of assets such as a serial number of the asset, globally unique identifier assigned to the asset, a description of the asset, an age of the asset, etc.; an identification of capabilities of each asset (e.g., processing speed or frequency, number of cores, capacity of volatile or non-volatile memories, any other characteristics associated with the asset, etc.); an identification of any dependencies between an asset and other assets of the set of assets (if any such dependencies exists or are known); an identification of one or more thresholds for each asset class, an identification of one or more thresholds of each asset; an age of each asset, a time interval over which the asset has been in-use (e.g., up-time of the asset), an identification of errors or failure reported by the device; an identification of errors or failures detected in the device; or the like. The network management configuration may be usable to manage the set of assets. For example, the network management configuration may be usable to determine when additional assets are to be allocated to the service during periods of high processing load or when assets may be deallocated from the service during periods of low processing load.

At block 604, the network management system may generate a utilization value indicative of a current utilization of the set of assets. The utilization value may be an integer, real number, percentage etc.) indicative of a quantity of a characteristic of the asset that is in use by the service. The characteristic may be particular to an asset class in which the asset belongs. For example, for memory assets the characteristic may correspond to an amount of memory (e.g., such as megabytes, gigabytes, etc.) that is being used by the service. For CPU assets, the characteristic may correspond to a quantity of cores of the CPU in use by the service, a quantity of the processing potential of the CPU in use by the service, etc. Examples of characteristics include, but is not limited to, a quantity of memory being used (such as volatile or non-volatile memory based on the asset class), a quantity of processing cores being used, a quantity of processing cycles being used, power consumption, bandwidth (e.g., data being transmitted per second such as Megabits per second, etc.), any other characteristic indicative of a quantity of the processing potential of the asset that is in use by the service. The network management system may generate utilization value for each asset, for each asset class, for each network in which the service is deployed, for each network of the enterprise system that is providing the service, combinations thereof (e.g., for each asset class in each network, etc.), or the like.

In some instances, the utilization value may correspond to a current utilization of different set of assets. The different set of assets may be similar (e.g., having a similar quantity of each asset class, etc.) such that characteristics of the different set of assets may be usable to determine how the set of assets may operate when in use by the service. The utilization value and the different set of assets may be real assets or virtual assets (e.g., manually or procedurally generated).

The network management system may obtain the characteristics associated with the set of assets from one or more devices configured to generate the characteristics (e.g., such has a device within which the asset operates, stores the characteristics, aggregates the characteristics (e.g., such as a device configured to monitor and/or management the service or network), from the service, from user input, etc. For example, a service may operate within one or more private networks and one or more public networks. The network management system may obtain the characteristics associated with the set of assets by requesting the characteristics from a management device each of the one or more private networks (e.g., a device configured to monitor or manage the operations of the private network) and a management device of each of the one or more public networks (e.g., a device configured to monitor or manage the operations of the public network). The management devices may obtain the characteristics and transmit them to the network management system or command the respective devices within which the assets are operating to transmit the characteristics to the network management system. Alternatively, the network management may obtain the characteristics directly or indirectly through one or more APIs exposed by the one or more private networks and/or the one or more public networks. In some instances, the network management system may receive the utilization information in real time (e.g., as a series of datasets, as a continuous stream, etc.). For example, the network management system may receive one or more real-time, continuous, data streams from each device that generates, stores, aggregates, etc. characteristics associated with the asset

At block 612, the network management system may generate an asset utilization dataset that corresponds to a set of utilization values received and/or generated over a predetermined time interval. For example, the network management system may generate utilization values as data associated with the set of assets is received. Once a predetermined quantity of utilization values is received or a predetermined time interval lapses, the network management system may generate the asset utilization dataset from the predetermined quantity of utilization values, or the utilization received over the predetermined time interval. The asset utilization may be usable to train various algorithms, statistical models, machine-learning models, users, etc. The predetermined quantity of utilization values and/or the predetermined time interval may be selected based on previously training iterations (e.g., of the algorithms, statistical models, machine-learning models, etc.), a target accuracy metric (e.g., accuracy, precision, area under the curve, logarithmic loss, F1 score, mean absolute error, mean square error, etc.) for the training process, user input, combinations thereof, or the like.

For example, the accuracy of the machine-learning model may be based on the quantity and quality of the information used to train the machine-learning model. The quantity of the information may be selected by adjusting the predetermined time interval. Increasing the predetermined time interval may increase the accuracy of predictions generated by the machine-learning model once trained (e.g., at the expense of the time needed to train the machine-learning model). Reducing the predetermined time interval may reduce the quantity of time needed to train the machine-learning model and enable use of the machine-learning model in instances when little data is available (e.g., such as for new services). The network management system (or a device or user associated with the service) may select, based on the service to manage managed, the quantity of assets in the set of assets, the target accuracy metric, the time interval over which the service has been operating, etc., the quantity of the predetermined quantity of utilization values and/or the length of the predetermined time interval.

At block 616, the network management system may train a machine-learning model using the asset utilization dataset. The machine-learning model may be configured to generate a prediction corresponding to one or more future characteristics (e.g., such as a utilization value, failure, etc.) associated with the set of assets (e.g., such as each asset, each asset class, etc.). Examples of machine-learning models may include, but are not limited to neural networks, recurrent neural networks, concurrent neural networks, deep learning networks, support vector machines (SVM), clustering, linear or logarithm regression classifiers, Naïve Bayes, Nearest Neighbor, adversarial networks, etc. The machine-learning model may be configured to generate single or multivariate predictions associated with the set of assets.

The machine-learning model may be trained using supervised learning, unsupervised learning, semi-supervised learning, reinforcement learning, combinations thereof, or the like. The network management system may train the machine-learning model over a predetermined quantity of iterations or until a predetermined accuracy metric (such as any of the previously described accuracy metrics) is reached.

In some instances, the network management system may train two or more machine-learning models using the same utilization dataset. The two or more machine-learning models may be of a same type or of different types. The two or more machine-learning models may be used to generate comparative predictions of one or more future characteristics. The network management system may execute each of the two or more machine-learning models to generate a corresponding two or more predictions associated with the set of assets and evaluate the two or more predictions for accuracy, precision, etc. Alternatively, or additionally, the network management system may evaluate the two or more machine-learning models using accuracy metrics. The network management system may then select the prediction having a highest evaluation (e.g., highest accuracy, etc.) or the machine-learning model having the best accuracy metrics for use in managing the set of assets and/or for presentation to the device associated with the service, a user associated with the service (e.g., such as an administrator of the service, etc.), or the like. Each time a prediction associated with the set of assets is to be generated, the network management system may execute the two or more machine-learning models and selected the corresponding output having the highest evaluation.

Alternatively, or additionally, the network management system may select the machine-learning model that generated the prediction having the highest evaluation (or having the best accuracy metrics). The network management system may use the predictions to manage the set of assets and/or present the predictions to the device associated with the service, a user associated with the service, users of the network management system, or the like. The selected machine-learning model may be configured to generate predictions associated with the service. The selected machine-learning model may continue to generate predictions associated with the service until one or more accuracy metrics of the machine-learning model fall below predetermined thresholds or until another machine-learning model is selected.

For example, the network management system may continuously evaluate the two or more machine-learning models to identify the machine-learning model of the two or more machine-learning models configured to generate the best predictions (e.g., as determined by accuracy metrics, an evaluation of predictions generated by the machine-learning model relative to other machine-learning models, etc.). The network management system may select the machine-learning model configured to generate the best predictions (e.g., the most accurate relative to the other machine-learning models, etc.) to be the primary machine-learning model. If another machine-learning model of the two or more machine-learning models begins generating predictions with a higher accuracy than the primary machine-learning model, then the other machine-learning model will become the new primary machine-learning model. The network management system may continuously evaluate the two or more machine-learning models and always use the machine-learning model that is best suited to generate predictions associated with the set of assets.

Alternatively, or additionally, the network management system may receive user input selecting a particular machine-learning model from the two or machine-learning models. The network management system may present characteristics of the two or more machine-learning models (e.g., an evaluation of the accuracy of previous predictions, the accuracy metrics, etc.) to enable a determination as to which machine-learning model should be selected for use in predicting characteristic associated with the set of assets. The network management system may present characteristics may present the characteristics in a manner that provides a simple comparison between machine-learning models (e.g., side-by-side, using colors to indicate which accuracy metrics or predictions are better, etc.).

In some instances, the two or more machine-learning models may be configured to operate together to increase the accuracy of the predictions generated by the network management system. For example, the two or more machine-learning models may be configured into an adversarial network wherein the output from a first machine-learning model may be passed as input into a second machine-learning model (and the output of the second machine-learning model may be passed as input into the first machine-learning model) to improve how predictions are generated by the first and/or the second machine-learning models. In the adversarial network, the first machine-learning model may be configured to generate predictions associated with the set of assets and the second machine-learning model may be configured to evaluate characteristics associated with the predictions (e.g., accuracy, precision, deviation, etc.). The output from the second machine-learning model may be usable to train the first machine-learning model (e.g., via supervised or reinforcement learning). Alternatively, or additionally, the two or more machine-learning models may be configured into an ensemble model in which the output of a first machine-learning model is an intermediary output usable as input into one or more next machine-learning models similar in structure to a multiple-layered neural network. The last machine-learning model of the ensemble model may generate a final output.

At block 620, the network management system may execute the machine-learning model (or the two or more machine-learning models if implemented) to generate a predicted utilization of a first asset of the set of assets at a future time. Alternatively, or additionally, the machine-learning model may generate a predicted utilization of each asset of the set of assets, of each asset class, etc. The network management system may continuously receive the characteristics associated with the set of assets. The network management system may generate a new asset utilization dataset that includes the utilization value of the set of assets over a particular time interval. The particular time interval may include the current time instant and extending backwards (historically) to a previous time instant. For example, the particular time interval may be 30 days such that the new asset utilization dataset includes utilization values of the values from the last 30 days. Alternatively, the particular time interval can be any historical time interval.

The new asset utilization dataset may include an identification of the future time. The future time may be selected by the network management system (e.g., based on a quantity of data used to train the machine-learning model, a quantity of available historical data used as input to the machine-learning model, etc.), user input, or the like. The future time may be a particular time instant or a time interval. For example, when a time instant is selected, the predicted utilization may correspond to a predicted utilization of the asset at that time instant. When a time interval is selected, the predicted utilization may correspond to a sequence of predicted utilizations of the asset over the time interval.

At block 624, the network management system may determine that the predicted asset utilization is greater than a threshold. In other words, the network management system may predict that the utilization of the first asset will be greater than the threshold at the future time (or for time intervals at time instant therein). The network management system may generate a state of the set of assets, the service, and/or the network in which the service operates at the future time (e.g., generating the predicted utilization of each asset class and/or asset at the future time). The network management system may then determine whether an action should be executed to improve the efficiency of the set of assets, the service, and/or the network in which the service operates.

The action may be determined may be based on predicted asset utilization being greater than a threshold. The action may be determined by the network management system, by the device associated with the service, by the service, by user input, and/or the like. Examples of actions include, but are not limited to requesting additional assets be allocated to the service, allocating additional assets to the service, requesting deallocation of assets from the service, deallocating assets from the service, requesting replacement of an asset, replacing an asset, requesting an asset be moved from one network to another network, moving an asset from one network to another network, identify dependencies between asset class or assets, generate a notification to the device and/or user associated with the service, generate an interface configured to present the real-time characteristics associated with the set of assets and/or the service, generate an interface configured to present the generated predictions, combinations thereof, or the like.

In some instances, the network management system may define multiple thresholds that may be usable to determine the action. The thresholds may be defined according to an escalating asset utilization. The network management system may determine the action to execute based on the particular threshold or thresholds that have been exceeded. For example, the thresholds for memory utilization may be 60%, 75%, and 90%. The network management system may determine that if the predicted memory utilization is greater than 60% but less than 75%, than a notification is to be transmitted to the device and/or user associated with the service. If the predicted memory utilization is greater than 75% but less than 90%, than a request to add additional memory assets to the service may be transmitted to the device and/or user associated with the service. If the predicted memory utilization is greater than 90%, than the network management system may automatically allocate additional memory assets to the service to prevent the service from being impacted.

At block 628, the network management system may facilitate the execution of the determined action in response to determining that the predicted utilization of the first asset is greater than the threshold. The determined action may correspond to any of the previously described actions. For example, if the predicted memory utilization indicates that the memory utilization is predicted to be greater than a threshold (e.g., 80% utilization) in the next seven days, the network management system may request transmit a request to the device associated with the service recommending that additional memory be allocated to the service.

In some instances, the network management system may determine how the determined action is to be executed to have the largest impact on the service. For example, a service may be provided using a combination of a private network and a public network, in which data is transmitted between the private network and the public network to provide the functionality of the service. When a high asset utilization is detected, in the public network (e.g., such as volatile memory utilization, the network management system may determine whether increasing the quantity of the asset in the public network, the private network, or both networks will alleviate the high asset utilization. For example, a high non-volatile memory asset utilization may be detected in a mixed network in which data is stored within the private network and transmitted to the public network for processing. Allocating additional non-volatile memory in the public network may have limited impact on the non-volatile memory utilization of the service because the data is stored in the private network. The network management system may determine that allocating additional non-volatile memory assets within the private network will have a larger impact on the service by reducing the overall non-volatile memory utilization of the service.

The network management system may evaluate the asset classes, assets of the set of assets, networks in which the service operates, combinations thereof, or the like to determine how allocating or deallocating assets within different networks or at different locations may affect other asset classes, assets of the set of assets, networks in which the service operates, etc. In some instances, the network management system may train and execute an action-prediction machine-learning model (e.g., such as any of the aforementioned machine-learning model, a new machine-learning model, etc.) configured to predict an effect of action on the service. The action-prediction machine-learning model may use an action-prediction asset utilization dataset that includes additional parameters configured to generate a targeted prediction indicative of a degree in which the action will impact other assets of the set of assets. The additional parameters may correspond to a result of executing the determined action. For example, if the determined action includes adding additional quantity of an asset, then the additional parameter includes the additional quantity of the asset such that the action-prediction asset utilization dataset includes the additional quantity of the asset in the inventory of the service.

For example, if the set of assets includes non-volatile memory with a total storage capacity of 500,000 GB and the additional parameters includes an additional 100,000 GB of non-volatile memory within a particular portion of the public network. The additional parameters will include the additional quantity of the asset within the particular portion of the public network such that the set of assets are treated as if the non-volatile memory asset includes 600,000 GB of non-volatile memory. The action-prediction machine-learning model may be execute using the action-prediction asset utilization dataset to determine a prediction based on the inclusion of the action (e.g., the additional quantity of the asset of the previous example) already being included with the set of assets. The action-prediction machine-learning model may generate a prediction based on the assumption that the action has already been performed to determine a predicted a new utilization of the first asset (or each asset class, each asset of the set of assets, or any characteristics of the set of assets or the service). Alternatively, or additionally, the action-prediction machine-learning model may generate a score indicative of a degree in which the action would be predicted to the service (e.g., based on any metric associated with the state of the service such as, but not limited to, efficiency, failure rate, false positives, false negatives, resource consumption, user complaints, etc.) if executed within a particular location of the service.

In some instances, the action-prediction machine-learning model may be executed multiple times with additional parameters that correspond to the action being executed at various locations within the service (e.g., with different devices, networks, etc.). The action-prediction machine-learning model may generate a corresponding multiple predictions with each prediction corresponding to the utilization of the first asset (or each asset class, each asset of the set of assets, or any characteristics of the set of assets or the service) if the action is executed at particular locations within the service. Alternatively, the action-prediction machine-learning model may generate the multiple predictions (or scores) in a single execution. The network management system may evaluate the predictions to determine which prediction (and corresponding location) resulted in a target outcome (e.g., a lowest predicted asset utilization for the first asset, another asset, each asset of the set of assets, etc.).

In some instances, the output from the machine-learning model and/or the action-prediction machine-learning model may be used to modify the machine-learning model and/or the action-prediction machine-learning model. The network management system may use the output from an execution of the machine-learning model and/or the action-prediction machine-learning model using reinforcement learning or the like to improve the accuracy and/or efficiency of the machine-learning model and/or the action-prediction machine-learning model. In some instances, each execution of the machine-learning model and/or the action-prediction machine-learning model generate an output (e.g., a prediction, a score, etc. as previously described) that can be augmented with feedback. The feedback may include a confidence metric (indicative of a confidence of the accuracy of the output), accuracy metrics (as previously described), user input, and/or the like. The feedback may be used along with the output and the asset utilization dataset that was passed as input into the respective machine-learning model to generate the output to modify the respective machine-learning model. The modification may result in the respective machine-learning model being configured to generate more accurate predictions.

In some instances, the action-prediction machine-learning model may be used to modify the machine-learning model. Predicting the result of executing the determined action may be used to indicate the accuracy of the prediction generated by the machine-learning model. The predicted result of executing the determined action may be fed back to the machine-learning model (along with the new asset utilization dataset and the prediction output from the machine-learning model) to modify the machine-learning model. The modification may result in the machine-learning model being configured to generate more accurate predictions. In those instances, the machine-learning model and the action-prediction machine-learning model may be configured as an adversarial network with a feedback loop that continuously modifies the machine-learning model to generate improved predictions.

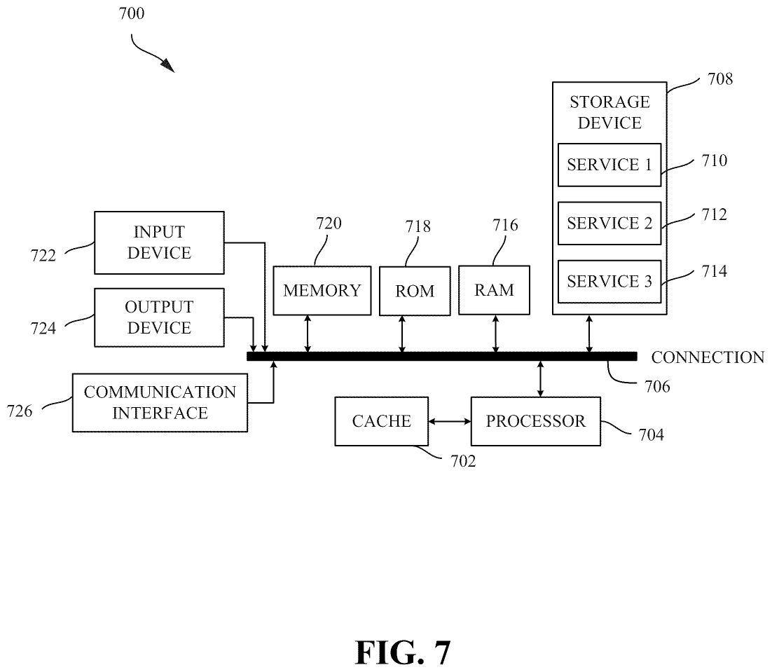

FIG. 7 illustrates an example computing device architecture of an example computing device that can implement the various techniques described herein according to aspects of the present disclosure. For example, computing device 700 can implement any of the systems or methods described herein. In some instances, computing device 700 may be a component of or included within a media device. The components of computing device 700 are shown in electrical communication with each other using connection 706, such as a bus. The example computing device architecture 700 includes a processor (e.g., CPU, processor, or the like) 704 and connection 706 (e.g., such as a bus, or the like) that is configured to couple components of computing device 700 such as, but not limited to, memory 720, read only memory (ROM) 718, random access memory (RAM) 716, and/or storage device 708, to processing unit 710.

Computing device 700 can include a cache 702 of high-speed memory connected directly with, in close proximity to, or integrated within processor 704. Computing device 700 can copy data from memory 720 and/or storage device 708 to cache 702 for quicker access by processor 704. In this way, cache 702 may provide a performance boost that avoids delays while processor 704 waits for data. Alternatively, processor 704 may access data directly from memory 720, ROM 817, RAM 716, and/or storage device 708. Memory 720 can include multiple types of homogenous or heterogeneous memory (e.g., such as, but not limited to, magnetic, optical, solid-state, etc.).

Storage device 708 may include one or more non-transitory computer-readable media such as volatile and/or non-volatile memories. A non-transitory computer-readable medium can store instructions and/or data accessible by computing device 700. Non-transitory computer-readable media can include, but is not limited to magnetic cassettes, hard-disk drives (HDD), flash memory, solid state memory devices, digital versatile disks, cartridges, compact discs, random access memories (RAMs) 725, read only memory (ROM) 720, combinations thereof, or the like.

Storage device 708, may store one or more services, such as service 1 710, service 2 712, and service 3 714, that are executable by processor 704 and/or other electronic hardware. The one or more services include instructions executable by processor 704 to: perform operations such as any of the techniques, steps, processes, blocks, and/or operations described herein; control the operations of a device in communication with computing device 700; control the operations of processing unit 710 and/or any special-purpose processors; combinations therefor; or the like. Processor 704 may be a system on a chip (SOC) that includes one or more cores or processors, a bus, memories, clock, memory controller, cache, other processor components, and/or the like. A multi-core processor may be symmetric or asymmetric.

Computing device 700 may include one or more input devices 722 that may represent any number of input mechanisms, such as a microphone, a touch-sensitive screen for graphical input, keyboard, mouse, motion input, speech, media devices, sensors, combinations thereof, or the like. Computing device 700 may include one or more output devices 724 that output data to a user. Such output devices 724 may include, but are not limited to, a media device, projector, television, speakers, combinations thereof, or the like. In some instances, multimodal computing devices can enable a user to provide multiple types of input to communicate with computing device 700. Communications interface 726 may be configured to manage user input and computing device output. Communications interface 726 may also be configured to managing communications with remote devices (e.g., establishing connection, receiving/transmitting communications, etc.) over one or more communication protocols and/or over one or more communication media (e.g., wired, wireless, etc.).

Computing device 700 is not limited to the components as shown if FIG. 7. Computing device 700 may include other components not shown and/or components shown may be omitted.

The following examples illustrate various aspects of the present disclosure. As used below, any reference to a series of examples is to be understood as a reference to each of those examples disjunctively (e.g., “Examples 1-4” is to be understood as “Examples 1, 2, 3, or 4”).

Example 1 is a computer-implemented method comprising: receiving a network management configuration that includes a configuration of a set of assets to be allocated to a service; generating a utilization value indicative of a current utilization of the set of assets; generating an asset utilization dataset include a set of utilization values generated over a time interval; training, using the asset utilization dataset, a machine-learning model configured to generate a prediction corresponding to a future utilization associated with the set of assets; generating, using the machine-learning model, a predicted utilization of a first asset, wherein the predicted utilization is associated with a future time interval; determining that the predicted utilization is greater than a threshold; and executing, in response to determining that the predicted utilization of the first asset is greater than the threshold, an action associated with the set of assets.

Example 2 is the computer-implemented method of any of example(s) 1 and 3-13, wherein executing the action causes additional assets to be added to the set of assets.

Example 3 is the computer-implemented method of any of example(s) 1-2 and 4-13, wherein executing the action causes additional resources to be allocated to the set of assets.

Example 4 is the computer-implemented method of any of example(s) 1-3 and 5-13, wherein executing the action causes assets to be removed from the set of assets, wherein assets removed from the set of assets are deallocated from the service.

Example 5 is the computer-implemented method of any of example(s) 1-4 and 6-13, wherein executing the action causes resources to be deallocated from the set of assets.

Example 6 is the computer-implemented method of any of example(s) 1-5 and 7-13, wherein the predicted utilization identifies a probable utilization of the first asset at over a future time interval.

Example 7 is the computer-implemented method of any of example(s) 1-6 and 8-13, wherein action associated with the set of assets is applied to a subset of the set of assets, and wherein the subset of the set of assets does not include the first asset.

Example 8 is the computer-implemented method of any of example(s) 1-7 and 9-13, further comprising: generating an updated asset utilization dataset using the asset utilization dataset and an identification of the action; and executing a training iteration of the machine-learning model using the updated asset utilization dataset.

Example 9 is the computer-implemented method of any of example(s) 1-8 and 10-13, wherein the asset utilization dataset includes historical data associated with a utilization of the set of assets over a selected time interval.

Example 10 is the computer-implemented method of any of example(s) 1-9 and 11-13, wherein the machine-learning model is selected from among two or more machine-learning models based on one or more metrics associated with the two or more machine-learning models.

Example 11 is the computer-implemented method of any of example(s) 1-10 and 12-13, further comprising: facilitating presentation of one or more hyperparameters of the machine-learning model; receiving a selection of a value of at least one hyperparameter of the one or more hyperparameters; and reconfiguring the machine-learning model based on the selection of the value of the at least one hyperparameter.

Example 12 is the computer-implemented method of any of example(s) 1-11 and 13, wherein the set of assets are assets of one or more cloud environments.

Example 13 is the computer-implemented method of any of example(s) 1-12, wherein the one or more cloud environments include public and private cloud environments.

Example 14 is a system comprising: one or more processors; and a non-transitory computer-readable storage medium storing instructions that when executed by the one or more processors cause the one or more processors to perform the operations of any of example(s)s 1-13.

Example 15 is a non-transitory computer-readable storage medium storing instructions that when executed by one or more processors cause the one or more processors to perform the operations of any of example(s)s 1-13.

Client devices, computing devices, processing devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 800 of FIG. 8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A computer-implemented method comprising:
receiving a network management configuration that includes a configuration of a set of assets to be allocated to a service;
generating a utilization value indicative of a current utilization of the set of assets;
generating an asset utilization dataset include a set of utilization values generated over a time interval;
training, using the asset utilization dataset, a machine-learning model configured to generate a prediction corresponding to a future utilization associated with the set of assets;
generating, using the machine-learning model, a predicted utilization of a first asset, wherein the predicted utilization is associated with a future time interval;
determining that the predicted utilization is greater than a threshold; and
executing, in response to determining that the predicted utilization of the first asset is greater than the threshold, an action associated with the set of assets.

2. The computer-implemented method of claim 1, wherein the predicted utilization identifies a probable utilization of the first asset at over a future time interval.

3. The computer-implemented method of claim 1, wherein action associated with the set of assets is applied to a subset of the set of assets, and wherein the subset of the set of assets does not include the first asset.

4. The computer-implemented method of claim 1, further comprising:
generating an updated asset utilization dataset using the asset utilization dataset and an identification of the action; and
executing a training iteration of the machine-learning model using the updated asset utilization dataset.

5. The computer-implemented method of claim 1, wherein the asset utilization dataset includes historical data associated with a utilization of the set of assets over a selected time interval.

6. The computer-implemented method of claim 1, wherein the machine-learning model is selected from among two or more machine-learning models based on one or more metrics associated with the two or more machine-learning models.

7. The computer-implemented method of claim 1, further comprising:
facilitating presentation of one or more hyperparameters of the machine-learning model;
receiving a selection of a value of at least one hyperparameter of the one or more hyperparameters; and
reconfiguring the machine-learning model based on the selection of the value of the at least one hyperparameter.

8. A system comprising:
one or more processors; and
a non-transitory computer-readable storage medium storing instructions that when executed by the one or more processors cause the one or more processors to perform operations including:
receiving a network management configuration that includes a configuration of a set of assets to be allocated to a service;
generating a utilization value indicative of a current utilization of the set of assets;
generating an asset utilization dataset include a set of utilization values generated over a time interval;
training, using the asset utilization dataset, a machine-learning model configured to generate a prediction corresponding to a future utilization associated with the set of assets;
generating, using the machine-learning model, a predicted utilization of a first asset, wherein the predicted utilization is associated with a future time interval;
determining that the predicted utilization is greater than a threshold; and
executing, in response to determining that the predicted utilization of the first asset is greater than the threshold, an action associated with the set of assets.

9. The system of claim 8, wherein the predicted utilization identifies a probable utilization of the first asset at over a future time interval.

10. The system of claim 8, wherein action associated with the set of assets is applied to a subset of the set of assets, and wherein the subset of the set of assets does not include the first asset.

11. The system of claim 8, wherein the operations further include:
generating an updated asset utilization dataset using the asset utilization dataset and an identification of the action; and
executing a training iteration of the machine-learning model using the updated asset utilization dataset.

12. The system of claim 8, wherein the asset utilization dataset includes historical data associated with a utilization of the set of assets over a selected time interval.

13. The system of claim 8, wherein the machine-learning model is selected from among two or more machine-learning models based on one or more metrics associated with the two or more machine-learning models.

14. The system of claim 8, wherein the operations further include:
facilitating presentation of one or more hyperparameters of the machine-learning model;
receiving a selection of a value of at least one hyperparameter of the one or more hyperparameters; and
reconfiguring the machine-learning model based on the selection of the value of the at least one hyperparameter.

15. A non-transitory computer-readable storage medium storing instructions that when executed by one or more processors cause the one or more processors to perform operations including:
receiving a network management configuration that includes a configuration of a set of assets to be allocated to a service;
generating a utilization value indicative of a current utilization of the set of assets;
generating an asset utilization dataset include a set of utilization values generated over a time interval;
training, using the asset utilization dataset, a machine-learning model configured to generate a prediction corresponding to a future utilization associated with the set of assets;
generating, using the machine-learning model, a predicted utilization of a first asset, wherein the predicted utilization is associated with a future time interval;
determining that the predicted utilization is greater than a threshold; and
executing, in response to determining that the predicted utilization of the first asset is greater than the threshold, an action associated with the set of assets.

16. The non-transitory computer-readable storage medium of claim 15, wherein the predicted utilization identifies a probable utilization of the first asset at over a future time interval.

17. The non-transitory computer-readable storage medium of claim 15, wherein action associated with the set of assets is applied to a subset of the set of assets, and wherein the subset of the set of assets does not include the first asset.

18. The non-transitory computer-readable storage medium of claim 15, wherein the operations further include:
generating an updated asset utilization dataset using the asset utilization dataset and an identification of the action; and
executing a training iteration of the machine-learning model using the updated asset utilization dataset.

19. The non-transitory computer-readable storage medium of claim 15, wherein the asset utilization dataset includes historical data associated with a utilization of the set of assets over a selected time interval.

20. The non-transitory computer-readable storage medium of claim 15, wherein the machine-learning model is selected from among two or more machine-learning models based on one or more metrics associated with the two or more machine-learning models.
